(19) United States
(12) Patent Application Publication
(10) Pub. No.: US 2006/0294243 A1
(43) Pub. Date: Dec. 28, 2006

(54) Management of group communication

(75) Inventors: Pekka Kuure, Espoo (FI); Tapio Paavonen, Pirkkala (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/254,694

(22) Filed: Oct. 21, 2005

(30) Foreign Application Priority Data
Jun. 23, 2005 (FI) 20055345

(51) Int. Cl. G06F 15/16

(52) U.S. Cl. 709/227

(57) ABSTRACT

A method of group communication in a system where clients need to request floor access from a controlling network element includes a controlling network element that determines a floor access control situation where number of floor access requests should be limited and sends a session-specific indication on the floor access control situation to the client. The indication includes a priority statement that the client compares to its own priority. If the assigned priority does not match with the priority statement, the client refrains from sending floor access request.

### FIELD OF THE INVENTION

The present invention relates to telecommunications, and more particularly to a method, a system, a network element, a user equipment, and a computer program product according to the preambles of the independent

### BACKGROUND OF THE INVENTION

In public communications systems, multi-user communication has traditionally been provided with a conference call service. A conference call is based on simultaneous individual telephone calls that are interconnected through a bridging facility, and allows users from several diverse locations to be connected for shared communication. Collecting a conference call by setting up the number of calls is a time-consuming task, and thus multi-user calls have not been widely used in public telecommunication. With the increasing and continually diverging usage of telecommunication, also the interest in instant group communication has recently risen remarkably.

A group is defined by a set of rules that identifies a collection of members. Group communication, as used herein, thus refers to a multipoint communication relationship that exists between the members of a group for the purpose of transferring data. Groups are created logically, which means that special group communication information maintained in the system associates a specific user with a particular group. One user may be a member in one or more groups, and the association can typically be dynamically created, modified and/or cancelled. Very often the members in a group belong to a specific organization, such as to a private company, a logistic fleet etc. One organization may have several individual groups, for example sets of groups, categorized according to their functional tasks. Also private persons may be associated to talk groups, such as hobby groups, sport groups, etc.

Conventionally, group communication has been available in trunked mobile communications systems, such as Professional Mobile Radio (PMR) systems. PMR systems are special radio systems primarily intended for professional and governmental users. In PMR systems, the group communication service functionality has mainly been inherently integrated into the switching and connection set-up or call control functionalities of the communications system. In a more recent approach, a public mobile communication system has been configured to provide the group communication service functionality as a packet-based user or application level service. In the solution, the underlying communications system provides the basic connections (e.g. IP connections) between the group communications applications in devices and the group communication service. An example of such solutions is Push-to-talk over Cellular (PoC), an overlay speech service provided by a communication server system.

One of the problems associated with the above arrangement relates to management of group communication, and especially to management of floor access in group communication. Floor access in this context relates to one member's access to the media delivery path. The operating situations where group communication is utilized comprise several instances where floor access of some members is critical for the ongoing action. It is very important that at all times some defined members of the group would be able to take the lead and get their message through to all other members as soon as possible and as frequently as necessary. Due to the dynamic nature of the operations and the related communication, the need for such diversified use may change dynamically. Thus preferably any applied control to the floor access should be dynamically adjustable.

Prior art solutions for floor access control propose use of queuing and priority. Priority herein refers to a value defined for a communicating unit, giving it a relative precedence to floor access. In European Telecommunications Standards Institute defined Terrestrial Trunked Radio (TETRA) systems, priorities are used to enable preferential access for defined call types (e.g. an emergency call) and/or for defined group members. In group communications, simultaneous speech item requests from different members are queued, and speech items are granted to queuing members by a procedure that takes into account the priorities of the members. Such priority based arrangement is also defined for PoC systems.

The problem is, however, that the actions necessary for getting to the queue and thus being part of the procedure where prioritizing may be applied also need to be accessed, and it generates traffic to the system. When several members try to get floor access and press their PTT-buttons, the communication gets congested and queuing and prioritizing members in queue may not work anymore. Congestion may concern only one particular group, for example an unexpected operational situation may drive a well operating group into communicational havoc, when everyone involved tries to get their observations and opinions overheard. Correspondingly, a general major incident may block the whole radio access system and important operational information gets drowned into the mass of chaotic communication. In the worst case, the traffic and attempts of access to a system may increase exponentially and the avalanche effect may collapse to whole system to be inoperable.

To prevent such severe situations, radio systems are typically arranged with technical means to control, limit or prevent the attempts of radio access by using priorities and broadcasted information on system access rules. For example, in a TETRA system the operator has an option to transmit from defined base stations at defined intervals an ACCESS-DEFINE packet data unit. The ACCESS-DEFINE packet data unit contains fairly slowly changing information about random access parameters for an access code, including the priority and mobile station binding. The binding of mobile stations defines a minimum valid priority for an access code. It may also restrict use of the access code to a set of subscriber classes, or to a group of mobile stations. The base station may dynamically optimize the system performance by varying the access code bindings with the other access parameters.

Another example of a radio interface level control mechanism is in the 3rd Generation Partnership Project (3GPP) specified GSM/EDGE radio access network (GERAN) system. In GERAN a base station may broadcast a PRIORITY_ACCESS_THR parameter indicating priorities that are allowed to attempt packet access in that particular cell. Packet access may thus be prevented in the whole cell or limited to a group of prioritized users, based on user priorities used by the terminal.

Consequently, there exists several arrangements to control the traffic load on radio layer. However, when considering end-to-end scenarios, and especially the dynamic nature of group communications, these mechanisms are not adequate. On radio access layer, different users are typically multiplexed to use a shared resource, and their priorities are adjusted applicable on the radio access system. However, their priorities on higher layers may greatly differ from that priority allocated on radio access layer. It may also be that there is no need to limit the access on radio layer, but detrimental congestion takes place on other layer or on a functional or logical group. For example, the load levels of the overall system may be low, but in certain particular communications group the communication may be overloaded. If there are tens of users in a group or conference and everyone tries to get access to floor, communication may not succeed as intended and in worst case the signaling channel related to floor control entity may end up being blocked.

Additionally, group members may reside in several different locations scattered around the whole coverage area. Mapping of a dynamic group level need to the physical configuration of the network is extremely complicated and performing appropriate control operations in a various number of cells is practically impossible. Furthermore, it is clear that while there may be several different and overlapping groups, a further mechanism would be needed to arbitrate between the needs of different groups.

### BRIEF DESCRIPTION OF THE INVENTION

An object of the present invention is thus to provide a method, a system, a network element, a user equipment, and a computer program product so as to enhance the control of floor access in a group communication. The objects of the invention are achieved by a method and an arrangement, which are characterized by what is stated in the independent claims. The preferred embodiments of the invention are disclosed in the dependent claims.

The invention is based on the idea of controlling the possibility to request floor access in a group session already before the requests end up congesting the system. A network element is arranged to monitor whether there exists a defined situation where enhanced floor access control for the session is necessary. When such situation is detected, the network element sends an indication to the user equipment of a defined member or defined members participating the session. After receiving the indication the user equipment checks the priority statement in the indication and compares it to its own priority. If its priority does not correspond with the priorities stated allowed in the priority statement, the user equipment refrains from sending floor access requests either until new and different information is received or for a defined period. The indication is valid for each group session separately.

An advantage of the invention is that improves group communication and optimizes use of network resources in systems that provide group communication.

### BRIEF DESCRIPTION OF THE DRAWINGS

In the following the invention will be described in greater detail by means of preferred embodiments with reference to the attached drawings, in which

FIG. 1 illustrates mobile communication system;

FIG. 2 illustrates a functional PoC architecture,

FIG. 3 a network configuration used in describing the exemplary embodiment;

FIG. 4 illustrates traffic flows in the embodied configuration of FIG. 3;

FIG. 5 illustrates traffic flows when invention is applied for controlling congestion in group communication;

FIG. 6 illustrates the procedure related to talk burst access right indication in a PoC server;

FIG. 7 illustrates the procedure related to talk burst access right indication in a PoC client;

FIG. 8 provides a functional description of a PoC server; and

FIG. 9 provides a functional description of a PoC client.

### DETAILED DESCRIPTION OF THE INVENTION

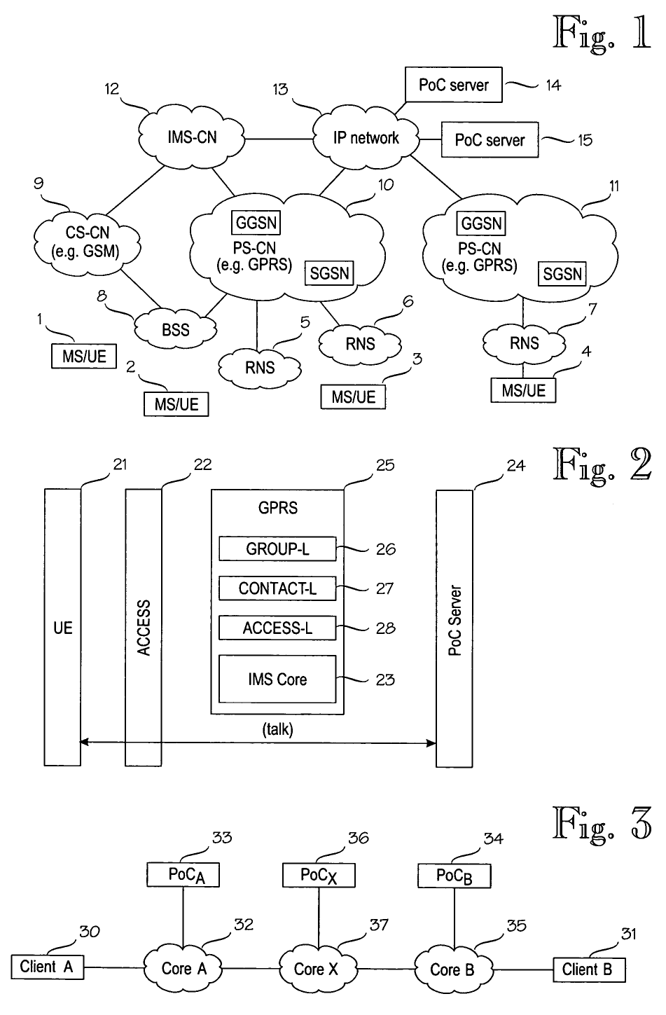

The present invention is applicable to any digital communication system that provides group communication service. Group communication, as used herein, refers to a multipoint communication relationship between members in a group for the purpose of transferring data. Members in the group are defined with special group communication information that associates a specific user with the particular group. As an example of a system environment where the present invention may be applied, floor access in a mobile communication system with a Push-to-talk over Cellular (PoC) server system is described with reference to FIG. 1. For a person skilled in the art it is clear that the invention is also applicable to other types of telecommunication systems capable of fulfilling the above requirement, for example to fixed telecommunication systems, and combinations of fixed and mobile communication systems.

As illustrated in FIG. 1, in the third generation (3G) mobile communications systems, a public land mobile network (PLMN) infrastructure may be logically divided into a core network (CN) 9, 10, 11, 12 and an access network (AN) infrastructures 5, 6, 7, 8. The access network AN may refer to, for example, a base station subsystem (BSS) 8 for a GSM and radio network subsystem (RNS) or a radio access network (RAN) 5, 6, 7 for UMTS. In the technical specifications of a third generation partnership project (3GPP), the core network CN is logically divided into a circuit switched (CS) domain 9, a packet switched (PS) domain 10,11 and an IP multimedia subsystem (IMS) 12. The CS domain refers to a set of core network entities offering a circuit switched type of connection for user traffic as well as all the entities supporting the related signaling. A circuit switched type of connection is a connection for which dedicated network resources are allocated upon connection establishment and released upon connection release. A packet switched type of connection, on the other hand, transports user information using packets so that each packet can be routed independently from a previous one. Examples of the PS domain may include the GPRS (General Packet Radio Service), and typical entities may include a serving GPRS support node (SGSN) and a gateway GPRS support node (GGSN). The IP multimedia subsystem comprises CN elements for provision of multimedia services. The IP multimedia subsystem IMS utilizes the PS domain to transport multimedia signaling and bearer traffic.

Push-to-talk over Cellular (PoC) is an overlay speech service in a mobile cellular network where a connection between two or more parties is typically established for a long period but the actual radio channels in the air interface are activated only when someone is talking. This corresponds to the usage of traditional radiotelephones where the radio frequency used is agreed between the parties (e.g. military/police radios, LA radios) or permanently set (walkie-talkie type of radios) and whenever someone wants to talk, she/he presses the tangent, which activates the radio transmission on the selected channel. The traditional radiotelephone services are, however, simplex by their nature so that only one party (the one who is pressing the tangent) can talk at a time.

More specifically, in voice communication with a “push to talk, release to listen” feature, a call is based on the use of a pressel/button (ptt, push to talk switch) in a telephone as a switch: by pressing a pressel/button the user indicates his/her desire to speak, and the user equipment sends a service request to the network. Alternatively, a voice activity detector (VAD) or any suitable means can be used instead of the manual switch. The network either rejects the request or allocates the requested resources on the basis of predetermined criteria, such as the availability of resources, priority of the requesting user, etc. At the same time, a connection is also established to a receiving user, or users in the case of group communication. After the voice connection has been established, the requesting user can talk and the other users can listen. When the user releases the button, or in the case of traffic inactivity, the event is detected in the network. The resources may be released and/or a talk item may be granted to another user.

In FIG. 1, a Push-to-talk over Cellular (PoC) server system is provided on top of the packet switched (PS) core network 10, 11, 12 in order to provide a packet mode (e.g. IP) group communication services to a user of the User Equipment (UE) 1, 2, 3, 4. UE accessing the PS CN, and the PS core network itself, utilizes the services provided by the radio network subsystem (RNS) or radio access network (RAN) 5, 6, 7, 8 to provide packet-mode communication between the UE and a PS CN subsystem. The multiple access method employed in the air interface in the RAN may be Time Division Multiple Access (TDMA), Frequency Division Multiple Access (FDMA), Code Division Multiple Access (CDMA), or a combination thereof. In the 3^{rd} and higher generation mobile communications system the access method is primarily based on the CDMA. Further, because the traffic channels may have a wide bandwidth, corresponding to user data rates e.g. up to 2 Mbits/s, such access may also be referred to as a Wideband CDMA (WCDMA).

Conceptually, a packet based media communication system is provided on top of the mobile network in order to provide media communication services to user equipment through the communication system. The media communication system may be embodied as a server system, and it is generally referred to as a media communication server herein. A media communication system may comprise a plurality of media communication servers 14,15.

A media communication server 14, 15 may comprise control-plane functions and user-plane functions that provide packet mode server applications communicating with the communication client application(s) in the user equipment over the IP connections provided by the communication system. This communication includes signaling packets and voice or data communication packets. Since both group and user specific requirements are needed, there may be two kinds of control-plane functions. Session Initiation Protocol (SIP) sessions for group communications are handled by a Group Control Plane Function (G-CPF). When a user connects to a group, the G-CPF takes care of the related SIP invitation transaction and performs the proper mapping settings between the user's recipient and the network entities responsible for the related traffic distribution. A User-Control Plane Function (U-CPF) is basically the control plane interface between the IP network and the user. By this network entity, the users log on to the system and negotiate their operational settings (scanning settings, selected group etc.). U-CPF handles the user's profile and manages his or her one-to-one calls. It should be appreciated that this is just a logical separation, and both kinds of Control Plane Functions can be situated in the same computer. However, this logical separation of G-CPF and U-CPF enables users to join groups handled by G-CPF in different intranets or in mobile networks of different operators and IP domain. The division also brings scalability by allowing, in practice, an infinite number of groups or users in the system.

In a functional PoC architecture, as shown in FIG. 2, the subscriber and group management function is implemented in a Group and List Management Server (GLMS). In FIG. 2, User Equipment (UE) 21 represents a user terminal that comprises PoC application client software. Access 22 in the PoC architecture represents the radio access as well as other necessary nodes to achieve IP connectivity, as described above. An IMS Core 23 represents a number of Session Initiation Protocol (SIP) proxies and SIP registrars necessary for implementing IP multimedia services. Detailed technical specifications for an IP Multimedia Subsystem are publicly available in the 3GPP specifications, and correspondingly, specifications of Session Initiation Protocol are available in the IETF specifications, and therefore considered well known to a person skilled in the art.

In the functional PoC architecture, a PoC Server 24 represents a media communication server that is the end-point of SIP, Real-time Transport protocol (RTP) and Real-time Transport Control Protocol (RTCP) signaling, provides SIP session handling, policy control for access to groups, group session handling, access control, do-not-disturb functionality, floor control functionality, talker identification, participants information, quality feedback, charging reports and media distribution.

Herein group information relates to a defined information element that associates a specific user with one or more groups. Group information in PoC is structured into groups, contact lists and access lists. The operation of a Group and List Management Server (GLMS) 25 in PoC thus comprises management of groups 26, contact lists 27 and access lists 28 stored in the GLMS. Contact lists 27 are used for storing contact entries in the GLMS server, and act as address books for the PoC users in establishing an instant talk session with other PoC users or PoC groups. A PoC user may have one or more contact lists, and each contact list is uniquely identified by its SIP URI. The PoC user stores user contacts in lists of the type “user” and group contacts to lists of the type “group”. Entries within one list are of the same type. GLMS allows manipulation of contact lists, and manipulation of identities in a contact list. A user who creates a contact list will automatically become its owner, and basically only the owner is allowed to manipulate the list. The owner of the list may reliably create, store, modify, retrieve, and delete contact lists, as well as add and remove end user and group identities to/from the list and add and remove contact lists themselves. By specification, when the user stores or adds a new identity into the contact list, the GLMS validates that the given address [SIP Uniform Resource Identifier (SIP URI) or Telephone Uniform Resource Locator (TEL URL)] is syntactically valid, but does not validate that the identity represents an existing entity.

Access lists 28 are used to define who is allowed or is not allowed to reach the PoC user via PoC service. When the PoC Server 24 is requested to add a participant to a talk session, the access lists are matched against the identity of the initiator of the talk session request. An access list comprises definitions on who is or is not allowed to reach a specific user via the PoC service. A PoC user may have a list of blocked identities, also called a user reject list, and a list of granted identities, also called a user accept list. The access lists are activated or deactivated by setting an attribute “in use”. The GLMS allows the PoC user to manipulate identities and attributes of his/her own user accept lists and user reject lists.

Group lists 26 are used to define PoC specific groups. PoC users may store and retrieve groups located in the GLMS server as well as create and delete groups and change their attributes, including manipulation of lists that are part of a group definition. In creating the group, the GLMS validates that the given SIP URI or TEL URL is syntactically correct. A PoC user may have none or several groups defined.

For a person skilled in the art it is clear that the definitions in this context relate to the specific PoC embodiment of the present invention, and the invention should not be interpreted to be limited to the terms and definitions used herein. Group information that associates specific user with one or more groups may be structured arbitrarily according to the service utilizing group communication.

The invention is first illustrated in context of a pre-arranged group session setup, originated by an inviting PoC client 30. A pre-arranged PoC group is a group having a pre-defined group identity and member list. A prearranged PoC group session is initiated by one of the members, and when a pre-arranged PoC group session is initiated, all other group members are invited. The pre-arranged PoC group session is established by using the group identity in the invitation message. FIG. 3 illustrates a configuration used in describing the exemplary embodiment. The inviting procedure is essentially similar for one-to-one and group sessions, so only one invited PoC client 31 is shown. For a person skilled in the art it is clear that the terminating functions may be repeated for each member of the invited group.

An inviting PoC Client 30 is arranged to send all its requests to the SIP/IP Core of its own network, hereinafter denoted as CoreA 32. The inviting PoC Client 30 indicates in the request that it communicates using PoC so that it is possible for CoreA 32 to route the requests to the PoC Server of the inviting PoC Client PoC_{A} 33. The request is delivered conventionally through SIP/IP core configuration to a PoC Server PoC_{B} 34 of the invited client PoC_{B} 31. When the network of the invited client PoC_{B} 31 receives the request it performs any necessary terminating service control, and if the session establishment is determined to continue, the terminating PoC Server PoC_{B} 34 routes the request to the terminating client via the SIP/IP Core of the invited client PoC_{B} 31, hereinafter denoted as CoreB 35.

In general, a PoC Server implements the application level network functionality for the PoC service. The PoC server may have different roles, and the determination of the role of the PoC Server (Controlling PoC Function and Participating PoC Function) takes place during the PoC Session setup. The PoC server maintains the determined role for the duration of the whole PoC Session. In FIG. 3 this separation of the roles has been illustrated by three separate logical PoC servers, where PoC servers PoC_{A}, PoC_{B} of the inviting and invited clients illustrate the roles of participating PoC servers and a separate PoC server PoCₓ 36 illustrates the role of the controlling PoC server. For a person skilled in the art it is clear that the controlling PoC server PoC_{X} may represent, depending on the situation, a functionality implemented by either of the PoC servers PoC_{A}, PoC_{B} or a PoC server of another SIP/IP Core network CoreX 37. In the embodied case of a pre-arranged group session, the PoC Server owning/hosting the Group Identity performing the Controlling PoC Function is illustrated as a separate PoC server PoCₓ 36 of SIP/IP Core CoreX 37.

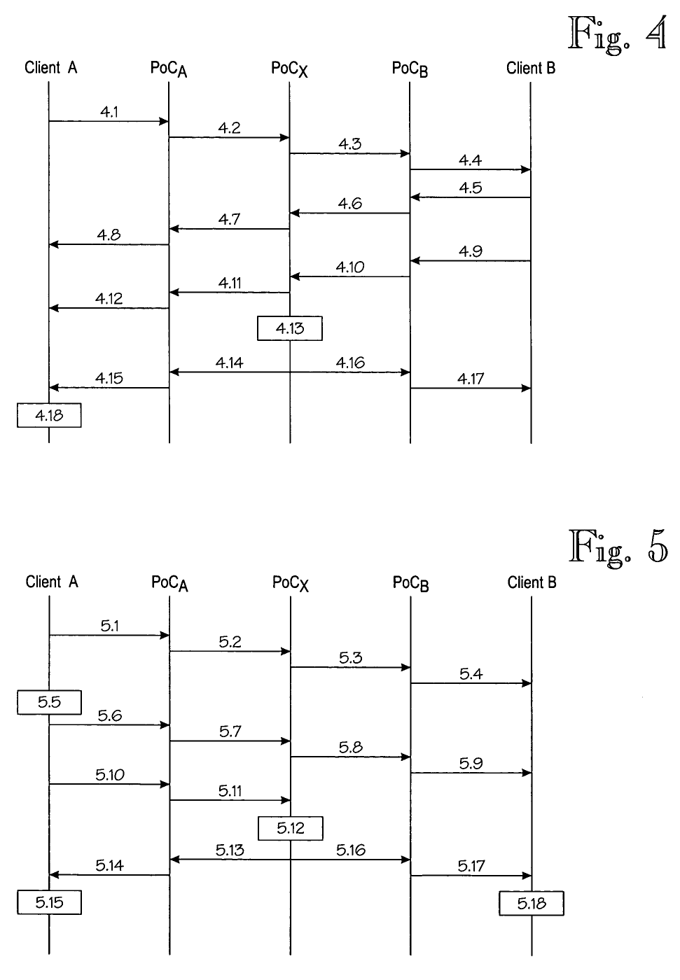

FIG. 4 illustrates traffic flows according to the invention in the embodied configuration of FIG. 3. It should be noted that for conciseness only elements and signals necessary for illustrating the invention are shown. Steps 4.1-4.4 illustrate the delivery of an INVITE request of the inviting PoC client ClientA. The INVITE request from ClientA to PoC_{A} in step 4.1 carries at least following information elements: pre-arranged group identity of the group call, PoC address of the PoC user at ClientA, a PoC service indication, media parameters of ClientA, proposal for talk burst control protocol, and a manual answer override request, if selected by PoC Client A. PoC_{A} identifies that the prearranged PoC Group is not hosted by itself and sends the request through SIP/IP CoreA and CoreX to PoC_{X}. The INVITE request from PoCA to PoC_{X} in step 4.2 carries at least the following information elements: pre-arranged group identity of the group call, PoC address of the PoC user at ClientA, a PoC service indication, PoC_{A} selected media parameters, proposal for talk burst control protocol, and a manual answer override request, if selected by PoC Client A.

PoC_{X} performs the necessary terminating service control and thereafter invites the other members to the pre-arranged PoC session. In the case the PoC group session is already ongoing, the ClientA is added to the PoC Session. The INVITE request from PoC_{X} to PoC_{B} in step 4.3 carries at least the following information elements: PoC address of the PoC user at ClientA, media parameters of PoCx, a PoC service indication, PoC address of the PoC user at ClientB, PoCx assigned indication, proposal for talk burst control protocol, and pre-arranged group identity. The INVITE request from PoC_{B} to ClientB in step 4.4 carries at least following information elements: a PoC service indication, PoC address of the PoC user at ClientB, media parameters of PoC_{B}, manual answer request, proposal for talk burst control protocol, and prearranged group identity.

When the ClientB receives the INVITE request it sends back an ALERTING indication 4.5 that is transferred through PoCB to PoCx (step 4.6). When the ALERTING response is received PoCx sends a ringing response (4.7 and 4.8) towards ClientA. When ClientB receives the indication that the user accepts the PoC Session, ClientB sends OK response for the INVITE. The OK response is transferred through the PoC servers to ClientA (steps 4.9 to 4.12).

According to the invention, in step 4-13 the controlling PoC server checks a defined control condition to determine whether a need to control floor access exists or not. The control conditions and checking procedure is discussed in more detail below. When such need exists, PoCx sends a talk burst access right indication. In the embodiment of FIG. 4 the indication is comprised in a talk burst confirm response delivered from PoCx to ClientA (steps 4.14 and 4.15). PoCₓ also sends a receiving talk burst indication to ClientB (steps 4.16 and 4.17). When ClientA receives the indication it checks the priority statement in the indication, and if deemed necessary, refrains from sending talk burst requests for a defined interval, for example until the situation causing the need for controlling is over (step 4.18). The operation of a PoC client after receiving a talk burst access right is discussed in more detail later on. Clearly the indication is effective for the specific group session only. The further advantage of the embodiment is that the control may be applied right from the beginning of the session.

For a person skilled in the art it is clear that the above embodiment merely illustrates one implementation of the invention, and does not limit the scope of protection to the system, elements and messages used in the description. For example, the setup does not have to relate to a pre-arranged group session, but the invented procedure may be applied to several other types of session setups. The talk burst access right indication may be given in the actual setup phase (SIP INVITE) of the session, as described below, or transmitted separately to a member that joins (SIP REFER) on ongoing session at the time of joining the session. In the latter case the talk burst access right indication may be included, for example, in a the response message of the session setup (SIP REFER), or in a separate message delivered directly after the session setup.

Another alternative possibility for delivering the talk burst access right indication is to include it in any control message delivered during an ongoing session. FIG. 5 illustrates traffic flows according to the invention in such case. Steps 5.1 to 5.4 relate to messages of the stage where ClientA has permission to send a talk burst. Media streams from ClientA to PoCₓ and PoCₓ forwards this media stream to the other PoC Clients in the PoC Session. As earlier, only Client B and the related PoC_{B} is shown in FIG. 5. When the user of ClientA releases the PoC button (step 5.5) and ClientA sends the last media packet to PoCₓ, who forwards it to ClientB. Step 5.10 and 5.11 illustrate delivery of Talk Burst complete-message from ClientA to PoCₓ. After PoCₓ has forwarded the last media packet, it then sends (steps 5.13 to 5.14 and 5.16 to 5.17) a No Talk Burst-message to all participants of the PoC session, including ClientA. According to the invention, PoCₓ checks a defined control condition to determine whether a need to control sending of talk burst requests exists or not. The control conditions and checking procedure is discussed in more detail below. When such need exists, PoCx sends a talk burst access right indication. In the embodiment of FIG. 5 the indication is comprised in the No Talk Burst-message, and is thereby delivered to all participant of the group call. After receiving the No Talk Burst-message, each of the PoC Clients gives a Talk Burst idle notification to its PoC User (steps 5.15 and 5.18). From there on, ClientA refrains from sending talk burst requests for a defined interval, for example until it is informed that the congestion situation is over. It may also notify the user about the control status of the group call. Clearly the indication is effective for the specific group session only. The further advantage of the embodiment is that it provides a possibility for dynamic control throughout the whole PoC session. The operation of a PoC client after receiving a talk burst access right is discussed in more detail later on.

For a person skilled in the art it is clear that in practical implementations there are several possible messages for delivering the floor access control indication. In the embodied system the message may be, for example, a separate SIP message or a separate floor control message comprising information for updating the access rights, or a readily specified floor control message embedded with new information on floor control access rights.

A need to control floor access may originate from several reasons, and the condition to be checked by the PoC server may be arranged in a number of ways according to any current application. One reason for controlling the talk burst requests may be congestion in group communication. When a group has several members and each one of them is trying to request a permission to send a talk burst, the communication in group gets congested from too many attempts. In such case the PoC server may be arranged to receive a congestion indication illustrating the congestion level of communication. When the PoC server determines that the congestion level exceeds a pre-defined level, it begins to include a talk burst access right indication to all new session setups, as described above.

The need for controlling floor access may also be based on operational strategies. A group that has many members may be allowed to operate without any additional controlling in normal conditions, but in urgent operating conditions it is important that only a higher rank group of members gets to talk, while the others only listen to the commands. Such dynamic control may be triggered manually or automatically, as described above. Naturally some groups may also be statically set to the allow talk burst requests only from defined members with appropriate priority levels.

The need for controlling floor access may also be based on the dynamic nature of the network usage. The system may comprise several groups that communicate independently. However, in case some major incident takes place, it is obvious that communication in all groups gets more frequent and the network begins to congest. In such case the network operator needs a toll to dynamically limit the communication for a defined number of prioritized users.

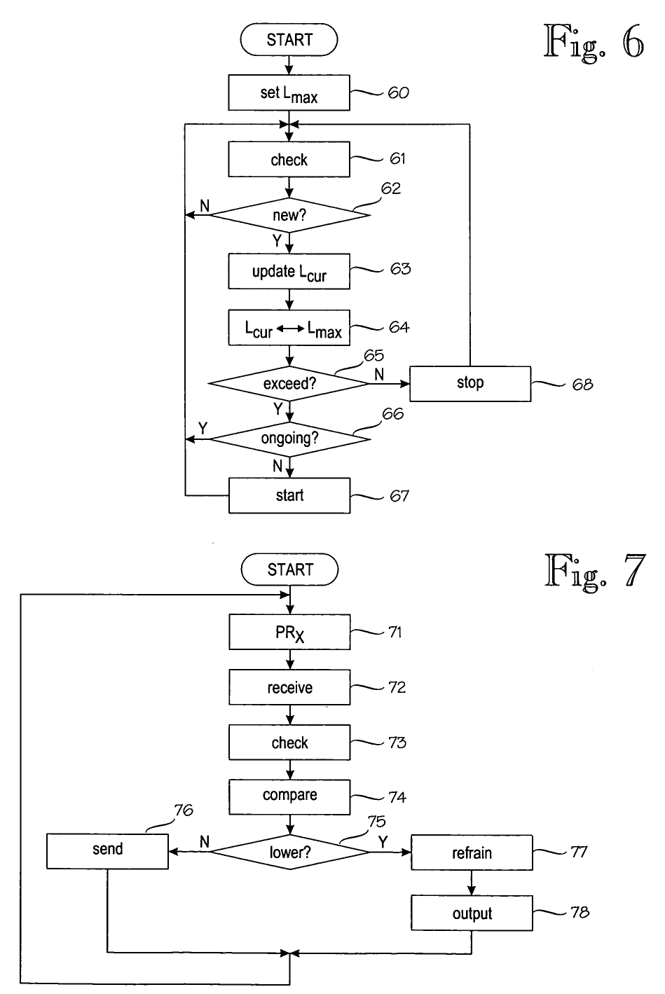

The indication may be automatic or manual. In an automatic indication the PoC server may, for example, be arranged with an application that monitors a parameter that corresponds with the congestion level of the communication. Such parameter may be, for example, the rate of talk burst requests in a predefined interval, or FIG. 6 illustrates the procedure in a PoC server in this exemplary case. In step 60 a threshold value Lmax for the congestion level is set. In step 61 the PoC server checks whether a new congestion indication is received. If yes (step 62) the current value Lcur of the congestion level is updated (step 63). The current value Lcur is compared with the threshold value Lmax (step 64), and if Lcur>Lmax (step 65), and no a talk burst access right indication is not on (step 66), the inclusion of the talk burst access right indication in No Talk Burst-messages is initiated (step 67). After this the procedure returns to the checking step 61. In case Lcur<Lmax, the threshold value is not exceeded and the inclusion of the talk burst access right indication in No Talk Burst-messages is ended (step 68).

In a manual indication the PoC server may, for example, be connected with a dispatcher application. A dispatcher that operates as a member of the group may monitor the group communication and based on his or her judgment send to the PoC server a congestion indication. Receiving of the congestion indication triggers inclusion of the talk burst access right indication in all new session setups, as discussed above.

According to the invention, when ClientA receives a talk burst access right indication from the PoC server, it adjusts its operation by refraining from sending of talk burst requests for a defined period. The period may be a predefined time interval, or the sending may be stopped until further instructions from the PoC server. The interpretation and further actions related to a received talk burst access right indication may be implemented according to the system. In the described PoC configuration, priorities are preferably used. Each PoC may be given a priority level. A user may have one priority that is valid for each group he or she is a member of, or separately set priorities for each group.

FIG. 7 illustrates the operation of a PoC client in the embodied configuration of FIG. 3. In step 71, the PoC client gets a priority PRx that is valid for a GroupM. This priority PRx may be a static parameter set in subscriber provisioning, set by the user with the client equipment, or even negotiated with PoC server or the server maintaining groups each time a session is established. In step 72, the PoC client receives a talk burst access right indication as described above. It checks the priority statement in the indication (step 73). The priority statement in this embodiment refers to information in the talk burst access right indication that defines a minimum priority that is, after receiving the indication, allowed to send talk burst requests. PoC client compares the statement with PRx (step 74). If the PRx is higher than the level set by the priority statement, it continues normal operation (step 76). If PRx is lower than the level set by the priority statement, it begins to refrain (step 77) from sending talk burst requests. Preferably the client also outputs the refrained status to the user, for example by outputting a symbol in the display of the client equipment, or playing a specific sound through the loudspeaker when the user presses the PTT-button. In this example the refrained status continues until a new indication, where the priority statement is lower than PRx arrives.

The format of the talk burst access right indication may be freely adjusted without deviating from the scope of protection. The usage of bandwidth is optimized when the indication is implemented as a reserved bit pattern, where the number of necessary bits is adjusted according to number of the priority levels. As an example, in a case of four priorities; Priority1 (P1), Priority2 (P2), Priority3 (P3) and Priority4 (P4) the corresponding bit pattern may be “XYZW” where X=P1, Y=P2, Z=P3 and W=P4. In this exemplary case, the bit patterns could be interpreted as follows:

“1000”=>Only Priority 1 members SHALL are able to request a Talk Burst (Floor)

“1001”=>Only Priority 1 and priority 4 members are be able to request the Talk Burst (Floor)

“1111”=>All members have rights to request a Talk Burst (Floor)

For a person skilled in the art it is clear that the actual indication may take different format. It could be as well a number presentation between 1 to 4 where e.g. number 2 would mean that Priority 2 and higher priorities (i.e. P1) have right to attempt access in the group.

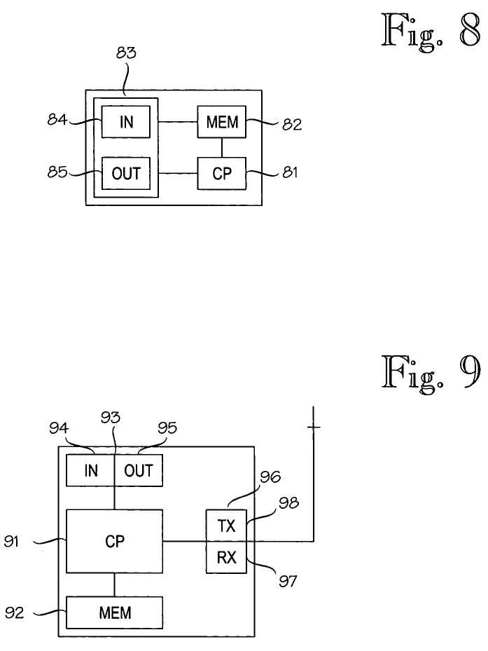

FIG. 8 provides a functional description of a PoC server according to the previously shown embodiment of the invention. By definition a server is a computer that serves other computers in the same or other networks by operating as the other computers request. The server of FIG. 8 comprises processing means 81, an element that comprises an arithmetic logic unit, a number of special registers and control circuits. Connected to the processing means are memory means 82, a data medium where computer-readable data or programs or user data can be stored. The memory means typically comprise memory units that allow both reading and writing (RAM), and a memory whose contents can only be read (ROM). The unit also comprises an interface block 83 with input means 84 for inputting data for internal processing in the unit, and output means 85 for outputting data from the internal processes of the unit. Examples of said input means comprise a plug-in unit acting as a gateway for information delivered to its external connection points. For receiving information on the operator, the server may also comprise a keypad, or a touch screen, a microphone, or the like. Examples of said output means include a plug-in unit feeding information to the lines connected to its external connection points. For outputting information to the operator of the server, they may also comprise a screen, a touch screen, a loudspeaker, or the like. The processing means 81, memory means 82, and interface block 83 are electrically interconnected for performing systematic execution of operations on the received and/or stored data according to the predefined, essentially programmed processes of the unit. In an embodiment according to the invention, such operations comprise a functionality for implementing the operations of the PoC server as described above.

The implementation of the described mechanisms in the user equipment is illustrated by referring to FIG. 9 that comprises a functional description of user equipment UE. The user equipment UE comprises processing means 91, an element that comprises an arithmetic logic unit, a number of special registers and control circuits. Connected to the processing means are memory means 92, a data medium where computer-readable data or programs or user data can be stored. The memory means typically comprise memory units that allow both reading and writing (RAM), and a memory whose contents can only be read (ROM). The user equipment UE also comprises an interface block 93 with input means 94 for inputting data by the user for internal processing in the unit, and output means 95 for outputting user data from the internal processes of the unit. Examples of said input means comprise a keypad, or a touch screen, a microphone, or the like. Examples of said output means comprise a screen, a touch screen, a loudspeaker, or the like. The user equipment UE also comprises a network unit 96 that is connected to the central processing means, and configured with receiving means 97 for receiving information from the network interface and processing it for inputting to the processing means 91, as well as with transmitting means 98 for receiving information from the processing means 91, and processing it for sending via the network interface. The implementation of such a network unit is generally known to a person skilled in the art. The processing means 91, memory means 92, interface block 93, and network unit 96 are electrically interconnected for performing systematic execution of operations on the received and/or stored data according to predefined, essentially programmed processes of the unit. In a solution according to the invention, the operations comprise the functionality of the user equipment UE as described above.

It will be obvious to a person skilled in the art that, as the technology advances, the inventive concept can be implemented in various ways. The invention and its embodiments are not limited to the examples described above but may vary within the scope of the claims.

1. A method of communicating in a group of clients, wherein a client is arranged to request floor access from a controlling network element, the method comprising:
assigning a priority to the client;
determining in the controlling network element a floor access control situation;
sending a session-specific indication on the floor access control situation to the client, said session-specific indication comprising a priority statement, from which priorities allowed to request floor access during said situation may be derived;
comparing the assigned priority of the client with the allowed priorities; and
in response to the assigned priority not matching with any of the allowed priorities, refraining from sending a floor access request to the session from the client.

2. A method according to claim 1, wherein the step of assigning comprises retrieving the priority from subscriber information of the user.

3. A method according to claim 1, wherein the step of assigning comprises negotiating the priority with a server managing the group of clients of the session.

4. A method according to claim 1, wherein the step of assigning comprises defining a separate priority for at least two groups the client is a member of.

5. A method according to claim 4, wherein the step of assigning further comprises negotiating the priority of the client for a specific group with the network element at a setup of a group session of said group.

6. A method according to claim 1, wherein the floor access control situation is determined in response to congestion in a radio interface of a communication system.

7. A method according to claim 1, wherein the floor access control situation is determined in response to congestion in communication of a defined group.

8. A method according to claim 1, wherein the floor access control situation is determined on a basis of an operational strategy.

9. A method according to claim 1, wherein the step of sending is performed at session setup.

10. A method according to claim 1, wherein the step of sending is performed during an ongoing session.

11. A method according to claim 1, wherein the session-specific indication is a bitmap embedded in a session setup response.

12. A method according to claim 1, wherein the session-specific indication is a bitmap embedded in a floor control message.

13. A communication system comprising a group of one or more clients and a controlling network element, wherein a client of the group is arranged to request floor access from the controlling network element, and
the system comprises means for assigning a priority to the client;
the controlling network element comprises means for determining a floor access control situation;
the controlling network element comprises means for sending a session-specific indication on the determined floor access control situation to the client, said session-specific indication comprising a priority statement from which priorities allowed to request floor access during said situation may be derived;
the client comprises means for comparing the assigned priority of the client with the allowed priorities; and
the client comprises means for refraining from sending a floor access request to the session from the client, in response to the assigned priority not matching with any of the allowed priorities.

14. A client for a communication network providing group communication, wherein a client comprises:
means for requesting floor access from a controlling network element of the communication network,
means for assuming a priority;
means for receiving a session-specific indication on a floor access control situation from the network element; said session-specific indication comprising a priority statement from which priorities allowed to request floor access during said situation may be derived;
means for comparing the assumed priority of the client with the allowed priorities;
means for refraining from sending a floor access request to the session from the client, in response to the assumed priority not matching with any of the allowed priorities.

15. A client according to claim 14, comprising user equipment and a subscriber identification module, wherein the means for assuming are arranged to retrieve the priority from subscriber data stored in a subscriber information module.

16. A client according to claim 14, wherein the means for assuming are arranged to negotiate the priority with a server managing a group of the session.

17. A client according to claim 14, wherein the means for assuming are arranged to assume a separate priority for at least two groups the client is a member of.

18. A client according to claim 14, wherein the means for assuming are arranged to negotiate a priority of the client for a specific group with the controlling network element at a setup of a group session of said specific group.

19. A network element for a communication system providing group communication, wherein a network element comprises:
means for granting floor access to a client in response to a request by the client;
means for determining a floor access control situation;
means for sending a session-specific indication on the determined floor access control situation to the client, said session-specific indication comprising a priority statement from which priorities allowed to request floor access during said situation may be derived.

20. A network element according to claim 19, wherein the means for determining are arranged to determine the floor access control situation in response to congestion in a radio interface of the communication system.

21. A network element according to claim 19, wherein the means for determining are arranged to determine the floor access control situation in response to congestion in communication of a defined group.

22. A network element according to claim 19, wherein the means for determining are arranged to determine the floor access control situation on a basis of an operational strategy.

23. A network element according to claim 19, wherein the network element is arranged to receive a floor access control situation indication from a dispatching system.

24. A computer program product, embodied on a computer-readable medium, executable in a user equipment of communication system, wherein the execution of the computer program product in the user equipment causes the user equipment to:
assume a priority;
receive a session-specific indication on a floor access control situation from the communication system, said session-specific indication comprising a priority statement from which priorities allowed to request floor access during said situation may be derived;
compare the assigned priority of the client with the allowed priorities;
refrain from sending a floor access request to the session from the client, in response to the assumed priority not matching with any of the allowed priorities.

25. A computer program product, embodied on a computer-readable medium, executable in a network element for a communication system, wherein the execution of the computer program product in the network element causes the network element to:
determine a floor access control situation;
send a session-specific indication on the determined floor access control situation to the client, said session specific indication comprising a priority statement from which priorities allowed to request floor access during said situation may be derived.
